(19) United States
(12) Patent Application Publication
(10) Pub. No.: US 2005/0079305 A1
(43) Pub. Date: Apr. 14, 2005

(54) Airbag cover and process for the production of an airbag cover

(75) Inventor: Matthias Krappmann, Forchheim (DE)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Kunststoff-Technik Scherer & Trier GmbH & Co KG, Michalau (DE)

(21) Appl. No.: 10/880,986

(22) Filed: Jun. 30, 2004

(30) Foreign Application Priority Data
Jun. 30, 2003 (DE) DE 103 29 380.9

(51) Int. Cl. B29C 45/16; B29C 45/73; B65D 1/00

(52) U.S. Cl. 428/35.7; 264/255; 264/328.16; 264/327

(57) ABSTRACT

The invention relates to an airbag cover (10) comprised of thermoplastic material, having at least one first partial region with a first surface-to-volume ratio and at least one second partial region (18) with a second surface-to-volume ratio, wherein the second surface-to-volume ratio is greater than the first surface-to-volume ratio, and which is manufactured by cooling a plasticized plastic that has been placed in a temperature-controlled casting mold until a degree of setting of the airbag cover (10) is achieved which allows removal from the mold, whereupon the airbag cover (10) is removed from the mold, wherein one adjusts the setting process in the second partial region (18) of the airbag cover (10) to the setting process in the first partial region by appropriately differing control of the courses of the temperature in the first partial region and the second partial region (18). According to the invention, the airbag cover (10) is comprised of two or more plastic components (50, 52).

The invention relates to an airbag cover comprised of thermoplastic material, having at least one first partial region with a first surface-to-volume ratio and at least one second partial region with a second surface-to-volume ratio, wherein the second surface-to-volume ratio is greater than the first surface-to-volume ratio, and which is manufactured by cooling a plasticized plastic that has been placed in a temperature-controlled casting mold until a degree of setting of the airbag cover is achieved that allows removal from the mold, whereupon the airbag cover is removed from the mold, wherein one adjusts the setting process in the second partial region of the airbag cover to the setting process in the first partial region by appropriately differing control of the courses of the temperature in the first partial region and the second partial region.

The invention also relates to an injection molding method of manufacturing such an airbag cover.

The invention further relates to an airbag cover comprising a first layer comprised of thermoplastic plastic, which has at least one second partial region with a rip-open seam in the form of at least one recess, and at least one first partial region with an essentially uniform layer thickness, wherein to produce the layer one cools a plasticized plastic that has been placed in a temperature-controlled casting mold until a degree of setting of the layer is achieved that allows removal from the mold, whereupon the layer is removed from the mold, wherein one adjusts the setting process in the second partial region of the layer to the setting process in the first partial region by appropriately differing control of the course (particularly the timewise course) of the temperature in the first partial region from the course of the temperature in the second partial region.

The injection molding of cast parts such as airbag covers with uniform wall thicknesses generally does not present any problems. If one seeks to have appreciable differences in wall thickness, however, i.e. in general if the surface to volume ratios in different partial regions of the cast part are to differ substantially from one to the other, the resulting cast part will often have appreciable deviations from the intended shape; e.g. it may have unintended indentations or prominences. Even if these deviations are only of the magnitude of tenths of a millimeter or less, the effect on the appearance of continuous visible surfaces (which may be structured) can be noticeable, e.g. when viewing light that is incident at an angle. The detriment to appearance is a problem, particularly in high valued products, such as automobiles. Depressions can be minimized by injecting additional plastic into the mold at high pressure during the cooling phase. However, the injection molds needed for this are costly, and energy consumption is high; moreover the reduction in local variations from the desired shape is not complete.

It is assumed that deviations from the intended shape in the region of large changes in the surface to volume ratio are attributable to locally disparate contraction behavior of the plastic, particularly based on different local temperatures. Accordingly, one might be able to correct the cooling behavior of the cast part by appropriate timewise temperature control of the mold. However, such an approach leads to a very undesirable prolongation of the cycle time, and thereby reduced productivity. Consequently, in practice one avoids large transitions in surface to volume ratio in cast parts; this caution is disadvantageous to manufacturing costs (greater consumption of plastic material) and may also be detrimental to achievement of the desired properties of the cast part.

Airbag covers must perform reliably in the event of a crash, to release the airbag that is being inflated. For this purpose, ordinarily an airbag cover is provided with rip-open seams that must reliably open in the event of a crash. These rip-open seams are comprised of grooves in the airbag cover. Thus the rip-open seams constitute a second partial region of the cast part with comparatively greater surface to volume ratio. They are located on the side of the airbag cover which is opposite to the visible side. In general, the course of the rip-open seam is noticeably visible on the visible surface of the airbag cover. As a rule, this is concealed to some extent by adjusting the design, e.g. by providing a design edge exactly in the region of the seam. Such a stratagem limits the freedom of design, however. Also, customarily, in order to reduce shape deviations, the groove depth is not very substantial; this necessitates particularly careful design of the rip-open seams, to ensure absolute reliability of tearing of the seams in the event of a crash.

In order to avoid deviations from the desired shape (particularly depressions or prominences) in the hardened cast parts, it is known to adjust the setting process in the second partial region of the cast part to the setting process in the first partial region by appropriately differing control of the courses of the temperature in the first partial region and the second partial region. It has been found that this improves the optical quality of the cast part. In the case of an airbag cover, the rip-open seam is less noticeably visible on the visible surface.

An airbag cover according to the preamble of claims 1 and 13 is known from GB 2,320,455 A. This airbag cover is manufactured with the aid of a casting mold that has an insert piece in the part of the mold provided for forming of the rip-open seam; the insert piece has lower thermalconductivity than the part of the mold employed for forming of the first partial region. In this way, the cooling of the second partial region, which bears the rip-open seam, is slower in comparison to the first partial region of the airbag cover, in order to adjust the setting processes of the two partial regions to each other and to reduce depressions on the visible surface of the airbag cover. The rip-open seam of the airbag cover according to GB 2,320,455 A, in a cross section perpendicular to the direction of extent of the rip-open seam, has the shape of a triangular groove, with the sides of the groove including an angle of about 100° and with the depth of the groove being about one half the thickness of the airbag cover.

Also, JP 2000-052390 A discloses a method of manufacturing plastic cast parts wherein a first partial region with a lower surface to volume ratio can be held at a lower temperature during setting than a second partial region with a higher surface to volume ratio. To accomplish this method, JP 2000-052390 A proposes a multipart mold wherein different parts of the mold are associated with the different partial regions having different surface to volume ratios, and said different parts of the mold are capable of having different temperature controls.

EP 0 006 289 A1 proposes a casting mold wherein plastic parts can be molded which have ribs or projections. To avoid occurrence of depressions on the visible surface of the plastic cast part opposite to the ribs or projections, insulation materials are inserted in the mold in the partial regions [of the mold] which are associated with the ribs or projections, in order to avoid excessively fast cooling of the surfaces of the ribs or projections.

Further, U.S. Pat. No. 4,548,773 discloses a plastic casting apparatus for casting of generally flat plastic pieces that have local increases or decreases in thickness. In the known apparatus, materials for conducting heat away are provided in parts of the mold intended for casting of the plate regions with greater plate thickness; these materials withdraw heat from the thicker plate regions more rapidly, in order to be able to achieve setting of thicker and thinner plate regions with equal speed.

In U.S. Pat. No. 6,146,576 a die is described in which plate-like parts of a composite material can be press-formed into a specified shape and can be set. The plate-like parts being formed are held between two halves of the die, wherein halves are electrically heatable. The known die enables parts having nonuniform shape or parts that are comprised of disparate materials to be formed in a die having a plurality of different heating zones, each of which zones can be operated at a different temperature. For this purpose, in particular, different operating flows can be supplied to different heating zones.

With airbag covers manufactured by customary injection molding methods, there still remains the following problem: In order to ensure a well defined and reliable ripping-open of the airbag cover in the event of triggering of the airbag, it is desirable to employ a rip-open seam that is as weak as possible, e.g. which has a groove that is as deep as possible, wherein the airbag cover is as thin as possible at the base of the groove and can be easily torn apart. However, when one has a very deep groove, despite the adjustments in the temperature course between the first and second partial regions, the pattern of the rip-open seams will be noticeably visible on the visible surface of the airbag cover. Further, a weak rip-open seam, particularly a deep such seam, reduces the overall strength of the airbag cover; consequently the installed airbag cover can suffer displaced edges or even undesired ripping-open of the seam. If, on the other hand, the depth of the groove is selected such as to reliably avoid an adverse effect on the surface quality of the visible surface, this may come at the cost of reduced reliability of ripping-open.

Accordingly, it is an underlying problem of the invention to devise an airbag cover that under conditions of varying surface to volume ratio offers improved external appearance while still ensuring optimal reliability of ripping-open.

According to the invention, this problem is solved by an airbag cover of the general type described supra, which is comprised of two or more plastic components. In this manner, it is possible to provide a second partial region of the airbag cover which region has a rip-open seam having a second surface-to-volume ratio, which [ratio] is chosen such that in the event of triggering of an airbag covered by the airbag cover the ripping-open of said rip-open seam is reliably ensured. The second plastic component serves to provide improved external appearance of the airbag cover.

If desired, the second surface-to-volume ratio may be chosen quite high, e.g. in the case of a groove the groove may be deeper, and/or the plastic employed may be of lower grade and thus less costly. A deeper groove in the airbag cover means that less tearing force is needed, thereby affording a greater freedom of design of the airbag cover without decreased reliability of the ripping-open (and with a reduction in the number of costly functional tests for the airbag cover). According to the invention, one can reduce the residual wall thickness of the airbag cover in the region of the groove by 30-40%.

Various means may be used to realize the different temperature courses in the first and second partial regions. In principle, local heating of the plastic material in the second partial region by electromagnetic irradiation is possible. However, it is simpler if, as proposed, the (possibly) multi-part casting mold is divided into sections associated with the respective partial regions, and these sections are held at respective different temperatures. The second partial region, because of its higher surface-to-volume ratio, tends to be cooled (and thus to be set) more rapidly in proximity to the colder mold than is the other cast region, but such more rapid cooling and setting is prevented, in that the section of the mold associated with said second partial region is kept at a higher temperature than the rest of the mold. The structure of the means for accomplishing this according to the invention may be simple. A customary casting mold with temperature control at a first temperature of, e.g., 50° C. may be employed up to the point of removal from the mold, but with some local heating, preferably via an electrical heating unit, to hold the second section of the mold at a second temperature which is about 30-100° C., preferably 50-60° C. higher than the aforementioned first temperature. Thus the second temperature may be 80-160° C., preferably 90-110° C., particularly preferably about 100° C. The second temperature is moderately below the softening temperature, preferably about 30° C. below.

It is assumed that the higher optical quality achieved by the differing temperature courses in the first and second partial regions is principally attributable to the fact that premature setting in the second partial region (e.g. the region of the rip-open seam) is prevented, by prevention of premature cooling. An evident consequence of such premature setting would be that the first partial region would set later and suffer movement of material, associated with the shrinkage of the plastic; and the already set region would not be able to adjust to that movement. The different temperature courses would lead to a nonuniform surface appearance, wherein the path of the seam could be noticeably seen on the visible surface.

A casting mold for manufacturing an airbag cover from thermoplastic plastic in the above-described manner can be provided as follows.

In order to realize the different operating temperatures in simple fashion, one might connect the first section and the second section to separate respective fluid temperature control systems. In view of the fact that in many cases the second partial region (e.g. the groove region) is smaller than the first partial region, advantageously a customary fluid temperature-controlled casting mold may be used, wherein some local heating (e.g. electrical heating) may be employed. One may provide a special insert piece that forms the second section of the mold. This insert piece may be in the form of an electrically heatable means, preferably comprising an insertable heating unit.

In the case of an airbag cover with a rip-open seam, the insert piece may have a rib corresponding to the seam, which rib forms the seam or a portion of the seam.

With the aim of rapid cooling of the mold piece overall and thereby a short cycle time, it is advantageous if the mold is comprised of heat conducting material, preferably conductive bronze. On the other hand, the insert piece may be comprised of material that is a poor heat conductor, in order to enable natural maintenance of the higher temperature in the second partial region. For this purpose, one may employ steel, preferably heat-treatable steel, which has the further advantage of high mechanical stability of the insert piece, particularly the sharp edged rib.

The particular shape of the insert piece depends on the design of the rip-open seam. For a star-shaped configuration of the rip-open seam, one may employ an insert piece with arms arranged in a star pattern. Advantageously, the arms are heated by heating units which are inserted in the arms.

One might also consider forming only a part of the rip-open seam to conform with the invention, e.g. if the other rip-open seams can be concealed by design edges or other design features, or can be located at relatively inconspicuous locations. In such a case, it may be sufficient to employ a simple insert piece which forms only a groove structure.

The invention further relates to an airbag cover comprising a first layer comprised of thermoplastic plastic, which has at least one second partial region with a rip-open seam in the form of at least one recess, and a first partial region with an essentially uniform layer thickness, wherein to produce the layer one cools a plasticized plastic that has been placed in a temperature-controlled casting mold until a degree of setting of the layer is achieved that allows removal from the mold, whereupon the layer is removed from the mold, wherein one adjusts the setting process in the second partial region of the layer to the setting process in the first partial region by appropriately differing control of the courses of the temperature in the first partial region and the second partial region. According to the invention, and to solve the above-described problem, with such an airbag cover it is provided that the airbag cover has on its outer side a second layer that overlaps at least the at least one second partial region of the first layer, wherein the second layer is comprised of a different material than the first layer.

As a rule, for an airbag cover mounted on a motor vehicle, the first layer is the layer facing the airbag, so that the second layer forms a visible surface of the airbag cover. Because the second layer covers the first layer in the region of the rip-open seams, and thus the seams are not visible from the exterior, there are no appreciable design limitations that impede the rip-open seams from being realized such that they are reliably ripped-open in a well defined manner in the event of triggering of the airbag.

The second layer may be comprised of a softer (more compliant) material than the first layer; this provides greater design freedom in designing the visible surface of the airbag cover, and facilitates reliable ripping-open of the rip-open seam.

The second layer may optionally be comprised of plastic, textile, leather, a film, or a combination of these materials. Particularly if a film is used as the second layer, a number of fabrication options are presented, e.g. production of an emblem by appropriate forming and/or printing (preferably on the interior side of the film). The described materials are readily deformable and are also adjustable to complex surface shapes of the airbag cover.

In order to further increase the reliability of tearing (of the seams), it is proposed that the second layer have a second rip-open seam in its region which overlaps the at least one partial region of the first layer. In the case of use of fabric or leather as the second layer, these materials may be pre-impaired at appropriate loci, e.g. by scratching.

In the first layer of the airbag cover, fabricated from thermoplastic plastic, preferably the recess is formed by a groove that has an essentially triangular or trapezoidal shape in a cross sectional plane perpendicular to the longitudinal direction of extent of the groove. In a casting process in a mold, such a groove can be formed by means of a rib on the mold, which rib has a triangular (or trapezoidal) cross sectional shape.

As mentioned, the inventive structuring of the airbag cover in at least two layers enables one to select the depth of the groove of the rip-open seam to be such as to ensure proper ripping-open of the airbag cover in the event of triggering of the airbag. According to one embodiment of the invention, the groove of the rip-open seam may even completely penetrate the first layer. This provides a particularly high reliability of ripping-open, because at this locus the rip-open seam is held together only by the second layer.

Alternatively, the groove may end at a distance from the second layer, which distance may be about 0.1-0.5 times the thickness of the first layer, preferably 0.1-0.2 times, particularly preferably 0.167 times (=⅙). With this structure, the first layer has particularly good mechanical stability in the region of the seam, without sacrificing reliable ripping-open of the rip-open seam when the airbag is triggered.

In order to achieve a particularly well defined ripping-open behavior, i.e. in order to be able to accurately determine the [actual operational] path of the rip-open seam in advance, with a trapezoidally shaped groove and/or a groove that completely penetrates the first layer it is advantageous if, in a plane perpendicular to the direction of extent of the groove, the groove at its narrowest point has a width in the range about 0.1-1.0 mm, preferably in the range 0.1-0.5 mm. Such a rip-open seam can be produced in a simple manner by having a mold half that forms a relatively sharply angled triangular groove on the inner side of the airbag cover be disposed directly against the opposite mold half.

In order to further improve the ripping-open behavior of the airbag cover, it is proposed that the side surfaces of the groove that extend in the direction of extent of the groove include between them an angle in the range 0-90°, preferably about 20-30°. This serves to decrease the overall width of the groove, so that when forces arising from the expanding airbag act on the groove one can achieve a better concentration of stresses in the region of the groove, whereby the ripping-open of the airbag cover at the appointed locus is better defined and more reliable.

The invention will be further described hereinbelow with the aid of exemplary embodiments, with reference to the drawings.

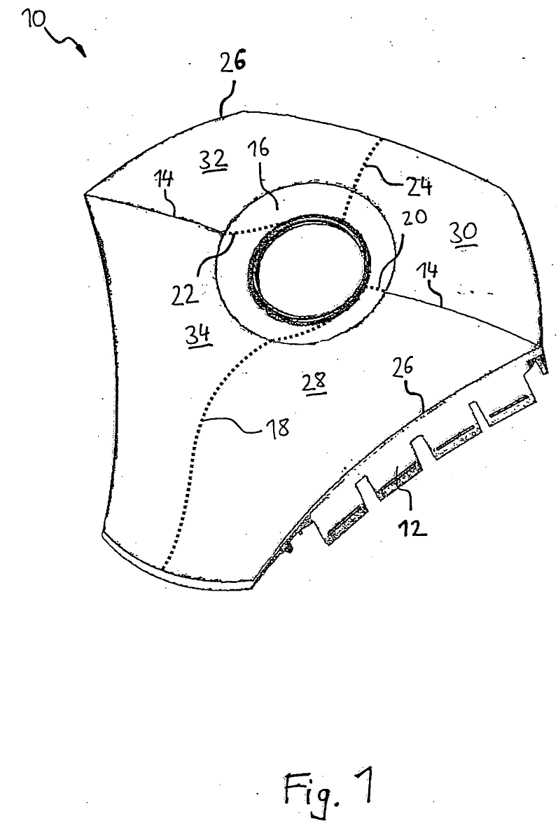

FIG. 1 is a perspective front view of an inventive airbag cover;

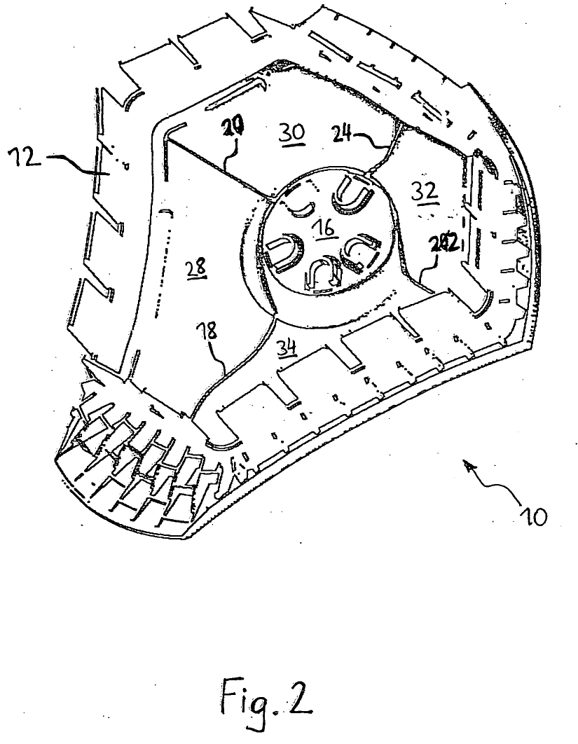

FIG. 2 is a perspective rear view of the airbag cover of FIG. 1;

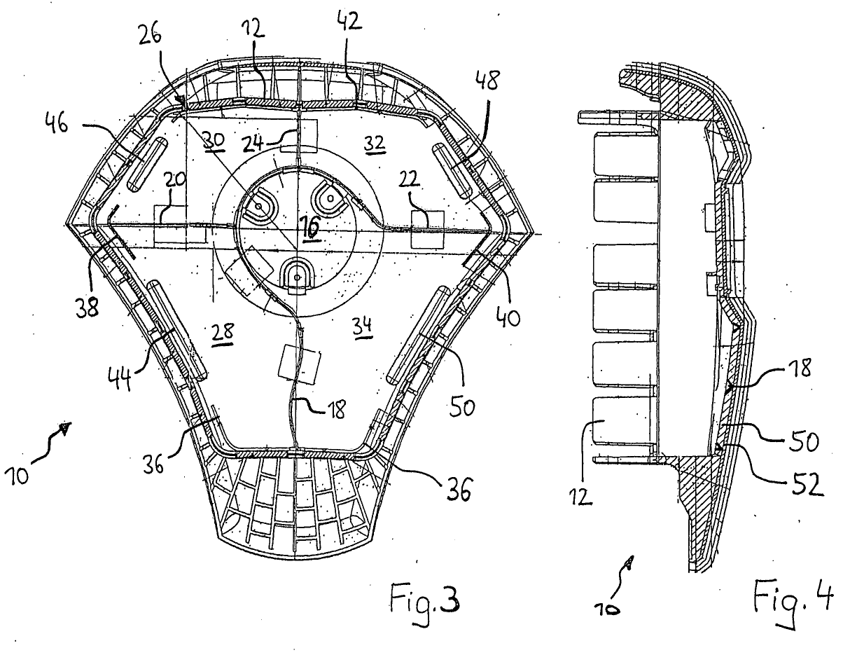

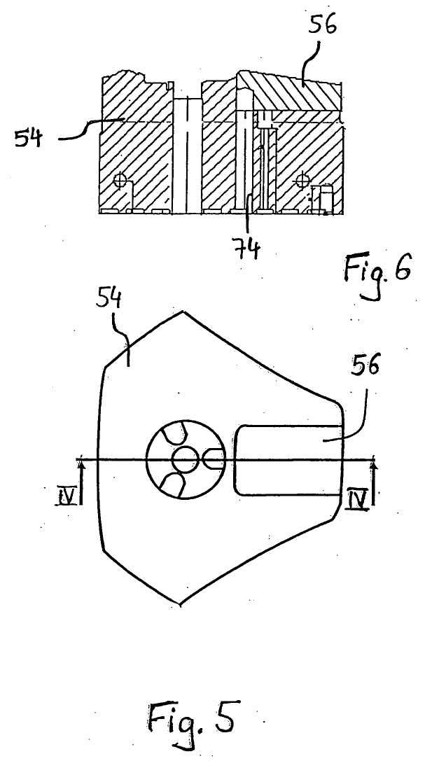

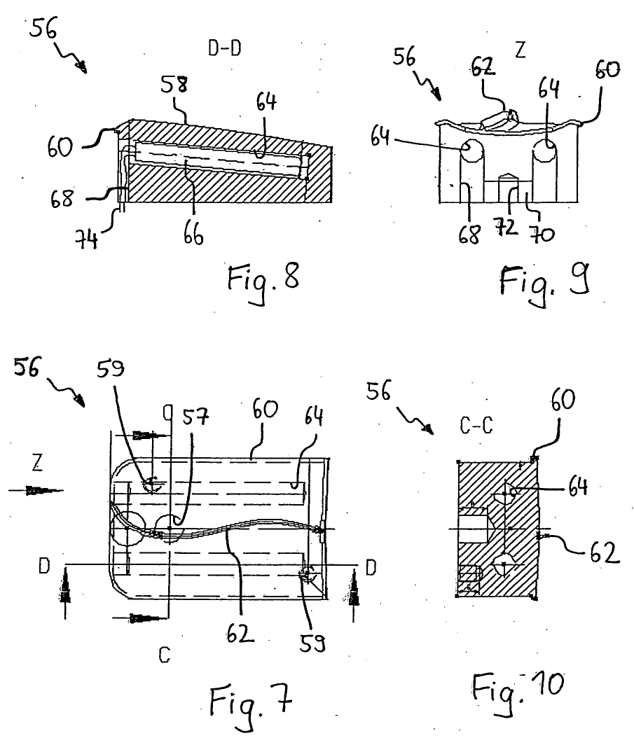

FIGS. 3 and 4 are, respectively, a rear and lateral view of the airbag cover of FIGS. 1 and 2;

FIG. 5 is a plan view of a forming tool for manufacturing an airbag cover;

FIG. 6 is a cross section of the forming tool of FIG. 5, through line VI-VI;

FIG. 7 is a plan view of an insert piece for the casting mold;

FIG. 8 is a cross section through line D-D of FIG. 7;

FIG. 9 is a front view of the insert piece according to FIG. 7;

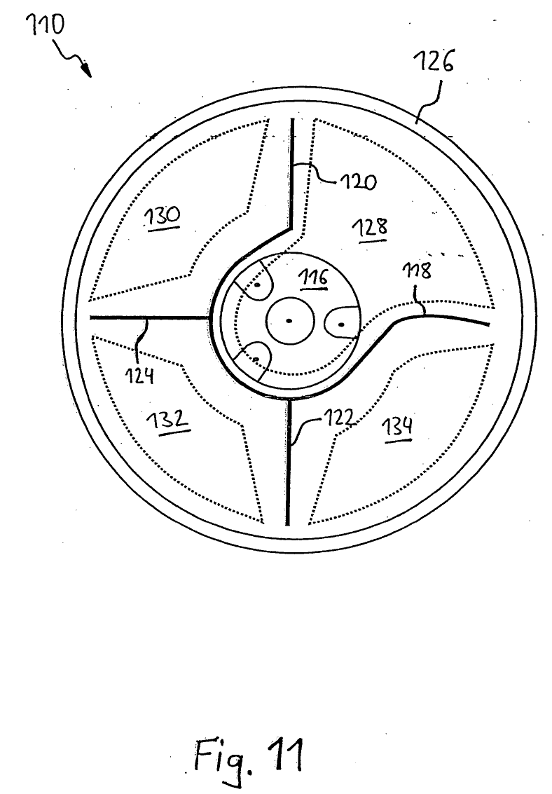

FIG. 10 is a cross section through line C-C of FIG. 7;

FIG. 11 is a bottom view of an airbag cover according to a second embodiment of the invention;

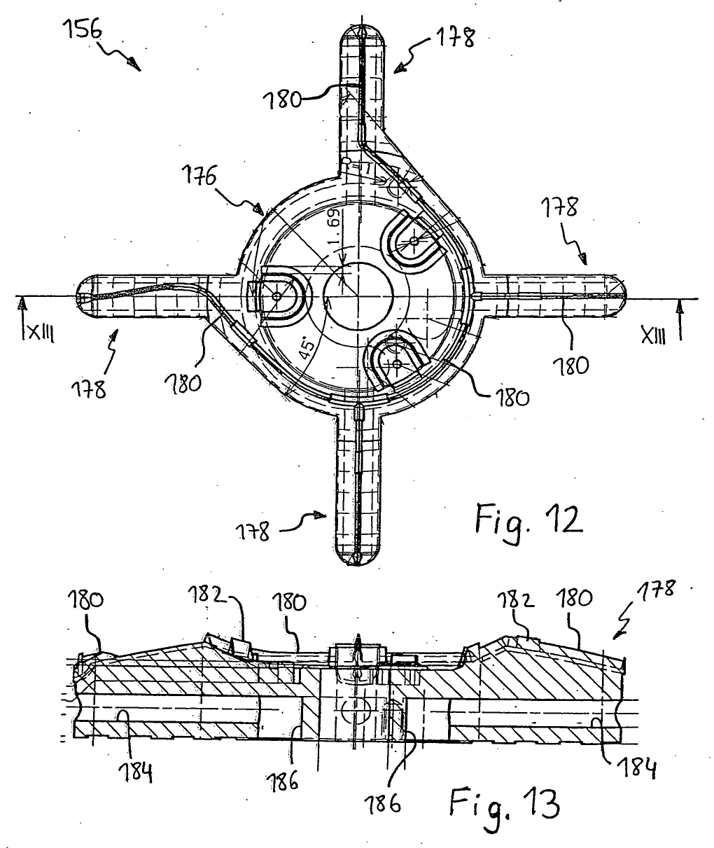

FIG. 12 is a plan view of an insert piece that is part of a forming tool for manufacturing the airbag cover according to FIG. 11;

FIG. 13 is a cross section through line XIII-XIII of FIG. 12;

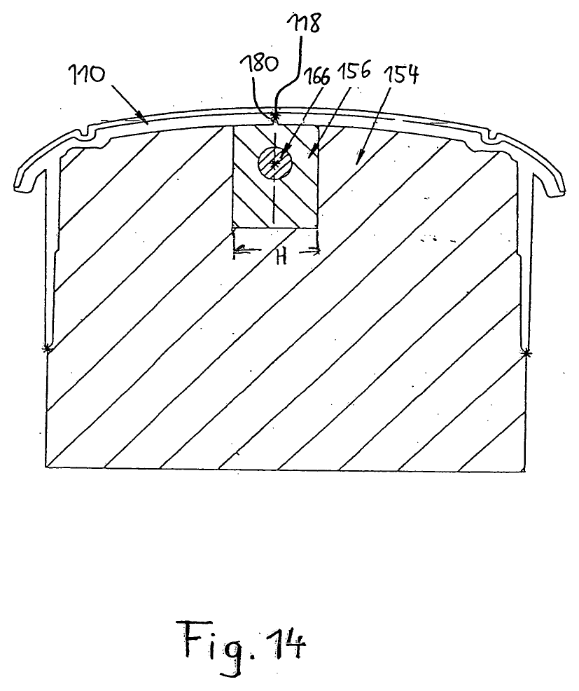

FIG. 14 is a schematic cross sectional view of a cast piece installed in an airbag cover;

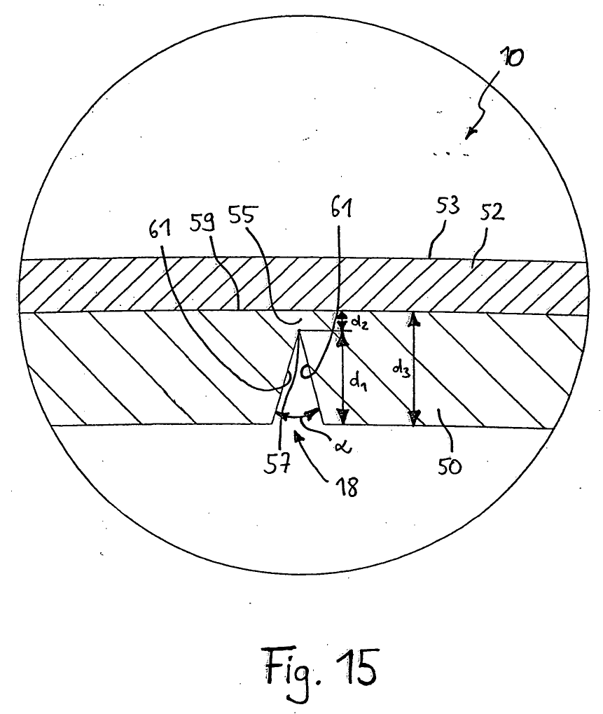

FIG. 15 is a cross sectional view of a first variant embodiment of the rip-open seam, in a plane of cross section that is perpendicular to the direction of extent of the seam;

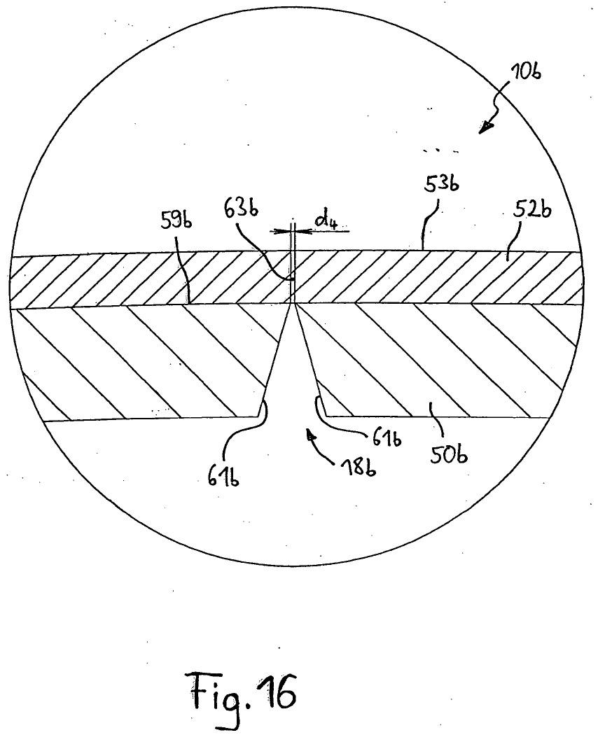

FIG. 16 is a cross sectional view of a second variant embodiment of the rip-open seam, in a plane of cross section that is perpendicular to the direction of extent of the seam; and

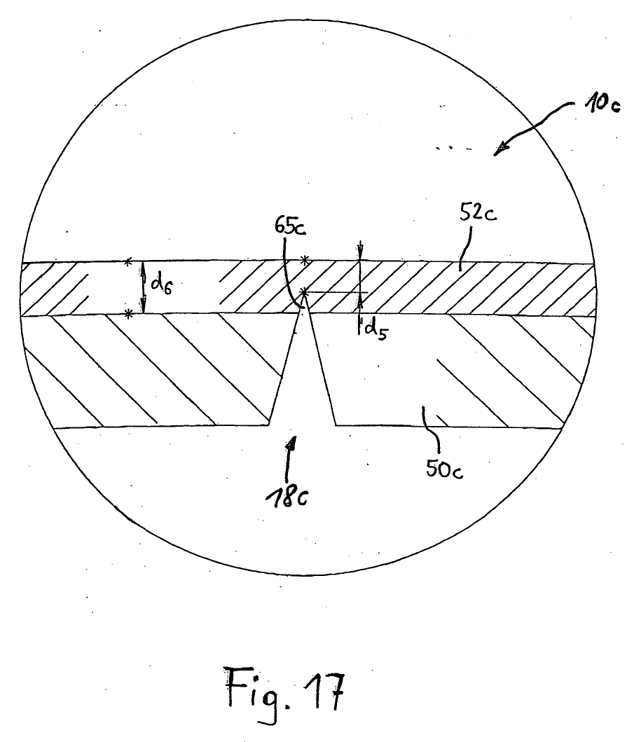

FIG. 17 is a cross sectional view of a third variant embodiment of the rip-open seam, in a plane of cross section that is perpendicular to the direction of extent of the seam.

FIG. 1 is a perspective plan view of an airbag cover (or cap), designated generally with reference numeral 10, which may be installed to cover an airbag in the region of the steering wheel of a motor vehicle. The airbag cover 10 has connecting strips 12 disposed on its peripheral edges, which strips can be interconnected with corresponding accommodation devices on the steering wheel. According to the design parameters of the airbag cover 10 of FIG. 1, the cover has a generally kite-shaped base surface and a slightly convex surface. There is a slight bend in this convex surface at each of two design edges 14, and a circular depression 16 is provided in the approximate center, which depression may hold, e.g. a manufacturer's emblem.

Four rip-open seams (18, 20, 22, 24) extend from the depression along the underside of the airbag cover 10, in directions that are approximately mutually perpendicular, toward the edge region 26 of the airbag cover 10. In this way, four rip-open flaps (28, 30, 32, 34) are formed, by virtue of the seams (18, 20, 22, 24) and the corresponding segments of the edge region 26 of the airbag cover 10; when the airbag explodes, these flaps (28, 30, 32, 34) swing upward in order to release the airbag, but the flaps remain connected to the airbag cover 10 in the edge region [26] of the airbag cover.

The rip-open seams 20 and 22 are disposed so as to primarily extend along the design edges 14, so that the optical appearance of the surface is not interfered with by any slight indentation or raising of the surface which may be produced in the region of these seams. Seam 24 is relatively short; thus in the region of seam 24 any indentation or surface raising is not visually very noticeable. On the other hand, rip-open seam 18 extends over a lengthy and readily visible region of the curved surface of the airbag cover 10, so that it is desirable to realize the form of this seam in a manner that is optically unimposing.

FIG. 2 shows a perspective bottom view (rear view) of the airbag cover 10, FIG. 3 shows a bottom cross sectional view, and FIG. 4 shows a lateral cross sectional view. As may be seen particularly from FIG. 3, at the ends of rip-open seams 18, 20, 22, and 24 directed toward the edge region 26, additional rip-open seams (36, 38, 40, 42) are provided which have defined paths along the edge region 26; these additional seams define hinge elements (44, 46, 48, 50) that provide the connection between the rip-open flaps (28, 30, 32, 34) during the flapping open. The hinges (44, 46, 48, 50) may be comprised of thickened regions of material.

It is seen from FIG. 4 that the airbag cover 10 is comprised of two plastic layers (50, 52), the lower layer 50 being comprised of a harder plastic that confers the necessary rigidity on the airbag cover 10, and the upper layer 52 being comprised of a softer (more compliant) plastic that satisfies specific design and comfort requirements. In FIG. 4 also, the rip-open seam 18 is shown as a groove having an approximately triangular cross section, which is formed in the inner, harder plastic layer 50 and which forms the second partial region having a relatively high surface to volume ratio.

FIGS. 5 and 6 show a plan view and a cross sectional view, respectively, of a part of a casting mold, which part serves to form the bottom side of the airbag cover. This part is comprised of a base body 54 comprised of a good heat-conducting material, e.g. copper or conductive bronze, formed such that it shapes most of the area of the bottom side of the airbag cover 10, the depression 16, the lateral strips 12, and the rip-open seams 20, 22, and 24. For this purpose, the base body 54 is mounted in known fashion in a second, wall-like part of the mold, the inner walls of which mold are shaped such that when the base body 54 is in its installed state a space occurs between the base body 54 and the inner walls of the wall-like mold piece, which space is in the shape of the airbag cover 10 that is being molded (cast). In known fashion, temperatures of the base body 54 and the wall-like mold piece may be controlled by means of a system of fluid conduits.

An insert piece 56 is installable in (or on) the base body 54, which insert piece forms the long rip-open seam 18 and the region around the seam. FIGS. 7-10 provide two facial views and two cross sectional views of said insert piece 56. The insert piece 56 may be comprised of, e.g., a heat-treatable steel, and has a shape that is generally rectangular. Following the shape of the airbag cover to be molded, the upper side 58 of the insert piece 56 has an angular transition with a slight curvature and is surrounded by a flange-like projecting edge 60 that allows it to be mounted to the base body 54. In addition, for mounting to the base body 54, the insert piece 56 also has a center bore 57 and two fastening bores 59 to accommodate fastening means. On the curved surface 58 a rib 62 with a triangular cross section is provided that serves to form the long rip-open seam 18 of the airbag cover.

In order to enable a different temperature course during the cooling of the airbag cover in the region of the seam 18, different from the temperature course in the rest of the airbag cover, the insert piece 56 has two interior bores 64 for accommodating a cylindrical heating element 66 (FIG. 8). For providing the contacts for the heating element 66, the insert piece 56 has machined passages 68 at the inlets to the bores 64, which passages 68 lead away from the openings of the bores 64; and piece 56 further has a transverse machined passage 70 which interconnects the passages 68. Further, a bore 72 transects the transverse passage 70, allowing the supply and return lines 74 from the heating element 66 to run from the bores 64 along the passages 68 and transverse passage 70 and finally through the bore 72, from there to run through a channel 74 through the base body 54 (FIG. 6), whereby they are accessible.

The following exemplary procedure may be employed for manufacturing an airbag cover 10. The insert piece 56 is fixed to the base body 54 by means of a centering screw 57 and fastening screws 59, and both pieces are combined with the wall-like mold piece, giving rise to a hollow space between the base body 54 (with the insert piece 56) and the inner walls of the wall-like mold piece which space corresponds in shape to the shape of the hard plastic layer 50 of the airbag cover 10. A plasticized plastic mass at about 200° C. is sprayed into this space. With the aid of the fluid temperature control system, the temperature of the base body 54 and the wall-like mold piece is kept at about 50° C., while the heating elements 66 of the insert piece 56 are operated such that the insert piece has a temperature of about 100° C., particularly in the region of the rib 62. The plastic mass that was initially at about 200° C. is thus cooled over its entire area adjacent to the mold, but the rate of cooling in the region of the rip-open seam 18 formed by the insert piece 56 is appreciably lower. In this way, by means of appropriate variations in the course of the temperature, it is possible to cause the setting process in the region of the rip-open seam 18 to approximate the setting process in the remainder of the curved surface of the airbag cover.

After the temperature of the plastic mass has generally adjusted to be equal to that of the mold pieces, the mold is opened and the hardened airbag cover is ejected. If desired, a second, softer plastic layer 52 can be applied, using ordinary methods.

FIG. 11 shows another exemplary embodiment of an airbag cover 110 in a bottom view. The cover has a peripheral edge region 126, a circular depression 116, and a plurality of rip-open seams 118, 120, 122, and 124 that partially surround the depression 116, leading from the depression to the edge region 126. In the event of an opening of the airbag, the seams 118, 120, 122, and 124 separate (rip open) and form four rip-open flaps (128, 130, 132, 134) that swing out in back of the plane of FIG. 11 (the separation lines (rip-open lines) are shown schematically by the dotted lines in FIG. 11), to allow the airbag to escape. Here the depression 116 is part of the flap 128. According to the design requirements of this airbag cover embodiment, all four rip-open seams extend below surfaces that are smooth or slightly structured and slightly curved, so that none of the rip-open seams is noticeably visible on the surface.

For this embodiment, a mold piece is used which is shown in a plan view in FIG. 12 and in cross section in FIG. 13. The shape-conferring part of the mold corresponds to insert piece 56, forming an insert piece 156 for a (not shown) base body. The mold piece has a central, essentially disc-shaped segment 176 and four arms 178 that are integrally connected to the segment 176. Ribs 180 run along the arms and along a border region of the disc-shaped segment 176. These ribs, which have an approximately triangular cross section, serve to form the rip-open seams 118, 120, 122, and 124 of the airbag cover. The locations of the ribs 180 adjacent to the center have expanded regions 182 on them which give rise to especially weak loci at the corresponding locations of the rip-open seams of the airbag cover, which weak loci serve as cleavage points for the start of the ripping-open process of the rip-open seams.

The insert piece 156 may have temperature control via electrical heating elements, analogously to insert piece 56 in the first embodiment. For this purpose, the arms 178 have longitudinal bores 184 that extend along the longitudinal extent of the arms, so as to accommodate respective cylindrical heating elements. Connecting bores 186 intersect the longitudinal bores 184, providing a path for the supply and return lines for the heating element, from the exterior, and allowing for connection means for these lines.

FIG. 14 is a schematic representation of the use of the insert piece 156 in forming of an airbag cover. The insert piece 156 is mounted in a base body 154, wherein, disregarding the rib 180, they (insert piece 156 and base body 154) together form an entirely smooth, slightly curved surface against which the surface of the plastic mass of the airbag cover 110 that is undergoing cooling lies. The rib 180 forms the rip-open seam 118 in the underside of the airbag cover 110. At the same time, the rib 180 is an instrument of the inventive temperature control in the region of the seam 118 and in a heating region defined by the width H of the insert piece 156, because the rib 180 is integrally connected (or at least connected in a fashion so as to provide good heat conduction) to the insert piece 156 that is being heated by the heating element 166. By means of a temperature control analogous to that described hereinabove, an airbag cover can be manufactured which is relatively thin and which has rip-open seams (118, 120, 122, 124) that can be reliably ripped open but are not noticeably visible on the visible surface of the airbag cover 110.

For a groove of cross sectional dimension in the neighborhood of about 1 mm, the width H of the heating region may be about 8-60 mm, preferably about 10 mm (depending on the design of the airbag cover).

Referring to FIGS. 15-17, three variants of a groove-shaped rip-open seam according to the invention will be described. Reference numerals here have the same signification as with the first embodiment of the inventive airbag cover; however, it goes without saying that the features which will be described hereinbelow may be equally applied for airbag covers according to the second and third airbag cover embodiments.

The airbag cover 10, shown in a partial cross section in FIG. 15, comprises a first layer 50 and a second layer 52. In an installation on a motor vehicle, e.g. on the steering wheel of the vehicle, for covering an airbag (not shown), the first layer 50 faces the airbag, and the second layer 52 faces away from the airbag, presenting a visible surface 53 of the airbag cover.

To provide a rip-open seam along which the airbag cover opens in the event of inflation of the airbag, a groove 18 according to a first variant (of such groove) extends into the first layer 50 from the side thereof facing the airbag, which groove has the essentially triangular cross sectional shape shown in FIG. 15. The depth d₁ of the groove 18 is appreciably more than half the thickness d₃ of the first layer 50, so that the thickness d₂ of the rippable part 55 of the first layer 50, comprised of material of the first layer 50 between the base 57 of the groove 18 and the face 59 of the first layer 50 that face faces away from the groove 18, is appreciably less than half the thickness d₃.

According to the invention, the depth d₁ of the groove 18 may be chosen such that the thickness d₂ of the rippable part 55 is small enough to ensure reliable tearing of the first layer 50 at the rippable part 55; the second layer 52 ensures an optimal appearance of the visible surface 53, in particular in the region of the groove 18.

Depending on the desired design of the airbag cover 10, the material used for the second layer 52 may be a plastic, e.g. TPE (thermoplastic elastomer), TE(PEEST) (thermoplastic polyester elastomer), TE(PEBBS+PP) (styrene-ethylene-butylene-styrene elastomer), or TE(PEUR) (thermoplastic polyurethane elastomer), with thickness about 1-2.5 mm, preferably about 1-1.6 mm. It is also conceivable to use a layer of woven fabric or other fabric or covering material, e.g. an interior covering material, having a thickness of up to 2 mm, a layer of leather having a thickness in the range 0.4-0.8 mm, or a film, which may be printed or preformed, for the purpose of, e.g., providing a vehicle emblem. The material for the first layer 50 of the airbag cover 10 as described above may also be comprised of a plastic, e.g. TE(EPDM+PP) or TE(EPDM−X+PP) (thermoplastic polyolefin elastomer with un-crosslinked or crosslinked EPDM), TE(PEEST), TE(PEBBS+PP), or TE(PEUR), with thickness in the range 2-3 mm.

To bond the first and second layers (50, 52) together, in the case of use of a plastic layer as the second layer 52 the plastic may be sprayed on or injection-molded on after the molding of the first layer 50. Alternatively, adhesives may be employed between the first and second layers (50, 52); the second layer 52 may be comprised of a film or other material (e.g. leather or fabric).

Another possibility for producing a simple and particularly reliable bond between a film as the second layer 52 and the first layer 50 is to apply the second layer as a molding substrate in the injection molding or the like of the first layer 50. The film, which may be pre-printed, and/or may be pre-formed for easier adjustment to the shape of the airbag cover, is inserted directly into the casting mold for the first layer 50, so that it comes into contact with the plasticized plastic for the first layer 50.

The groove 18 according to the first variant of the rip-open seam is further distinguished in that the groove angle α included between the side surfaces (61, 61) of the groove is less than 90°, and preferably is in the range 20-30°. In this way, the overall width of the groove 18 in the plane of the first layer is reduced, so that the ripping behavior can be improved by concentration of the ripping stresses on a smaller region.

A second variant of the rip-open seam of the inventive airbag cover 10b is illustrated in FIG. 16. The rip-open seam of this variant is also formed by a groove 18b in the first layer 50. However, in contrast to the groove 18 of the first variant, the groove 18b extends completely through the first layer 50b. Such a groove extending completely through the first layer 50b can have a triangular cross section, if the two side surfaces of the groove meet exactly at a surface of the first layer 50b. In the second variant (FIG. 16), however, the groove 18b has a trapezoidal cross sectional shape, wherein the side surfaces of the groove (61b, 61b) are separated by at least a distance d₄ at the contact surface 59b between the first layer 50b and the second layer 52b. The distance d₄ between the side surfaces is preferably in the range 0.1-0.5 mm, and thus is relatively small with respect to the thickness of the first layer 50b (which is preferably in the range about 2-3 mm).

When employing a rip-open seam according to the second variant (FIG. 16), the seam is thus closed off only by the seam region 63b of the second layer 52b, which seam region is opposite to the groove 18b. In the event of triggering of the airbag covered by the airbag cover 10b, the only resistance that needs to be overcome is that of the seam region 63b of the second layer 52b, wherein the airbag cover 10b rips open in a reliable and defined manner.

When employing a rip-open seam according to the second variant, it may be advantageous to use as the material for the second layer 52b a relatively shape-stable material, such as, e.g., a second plastic layer, in order that in the closed state of the airbag cover 10b an optimal external appearance is presented, and the rip-open seam is not noticeably visible on the visible surface 53b of the airbag cover 10b.

A third variant of the inventive airbag cover 10c, as illustrated in FIG. 17, may be employed in order to be able to improve the reliability of ripping and better define the position of the ripping locus of the second layer. In this variant, a rip-open seam 65c is provided in the second layer 52c in a region near the rip-open seam of the first layer, wherein in this seam 65c the second layer 52c may be, e.g., pre-impaired. If a film is used as the second layer 52c, which film is employed as a substrate in the injection-molding process for forming the first layer 50c, as described supra, a tool can be employed for pre-impairing the film right in the mold, so that the rip-open seam 65c is formed directly in the film at the time of the molding of the airbag cover 10c. Stated more precisely, a rib of the mold which rib forms the groove 18c that passes completely through the first layer 50c can accomplish the pre-impairment of the film with its apex (or comb structure) when the mold is assembled, so that the groove 18c passes completely through the first layer 50c and partly through the second layer 52c. The distance d₅ from the outer partial region of the second layer 52c is about 0.1-0.75 times the thickness d₆ of the second layer 52c, preferably 0.2-0.6 times, particularly preferably 0.5 times.

1. An airbag cover comprised of thermoplastic material, having at least one first partial region with a first surface-to-volume ratio and at least one second partial region with a second surface-to-volume ratio, wherein the second surface-to-volume ratio is greater than the first surface-to-volume ratio, and which is manufactured by cooling a plasticized plastic that has been placed in a temperature-controlled casting mold until a degree of setting of the airbag cover is achieved which allows removal from the mold, whereupon the airbag cover is removed from the mold, wherein one adjusts the setting process in the second partial region of the airbag cover to the setting process in the first partial region by appropriately differing control of the courses of the temperature in the first partial region and the second partial region;
characterized in that the airbag cover is comprised of two or more plastic components.

2. The airbag cover according to claim 1, characterized in that it has an at least approximately plate-shaped section that bears the first and second partial regions, wherein one side of the plate has a continuous visible surface that is common to the two partial regions, and wherein the second partial region has a plate thickness that is reduced in at least some locus/loci.

3. The airbag cover according to claim 2, characterized in that the second partial region is provided on its other plate side with at least one recess, which is preferably a groove.

4. The airbag cover according to claim 3, characterized in that the groove is configured as at least a part of a rip-open seam.

5. The airbag cover according to claim 3, characterized in that the recess penetrates one of the plastic components.

6. The airbag cover according to claim 3, characterized in that, for a recess having cross sectional dimensions on the order of 1 mm, the second partial region has a width H of 8-60 mm, preferably about 10 mm.

7. An injection molding method for manufacturing an airbag cover from thermoplastic plastic, which airbag cover has at least one first partial region with a first surface-to-volume ratio and at least one second partial region with a second surface-to-volume ratio, wherein the second surface-to-volume ratio is greater than the first surface-to-volume ratio, wherein in the molding method one cools a plasticized plastic that has been placed in a temperature-controlled casting mold until a degree of setting of the airbag cover is achieved which allows removal from the mold, whereupon the airbag cover is removed from the mold, wherein one adjusts the setting process in the second partial region of the airbag cover to the setting process in the first partial region by appropriately differing control of the courses of the temperature in the first partial region and the second partial region;
characterized in that one injection-molds the airbag cover from two or more plastic components.

8. The injection molding method according to claim 7, characterized in that a second segment of the possibly multipart mold, which segment serves to form the second partial region of the airbag cover, is held at a second temperature, and a first segment of the mold, which segment forms the first partial region of the airbag cover is held at a first temperature; and in that the second temperature is higher than the first temperature.

9. The injection molding method according to claim 8, characterized in that the second temperature is higher than the first temperature by about 30-100° C., preferably about 50-60° C.

10. The injection molding method according to claim 8, characterized in that when the material is removed from the mold the second temperature is at 80-160° C., preferably 90-110° C., particularly preferably about 100° C.

11. The injection molding method according to claim 8, characterized in that the second temperature is lower than the softening temperature of the plastic by 5-70° C., preferably 20-50° C., particularly preferably about 30° C.

12. An airbag cover manufactured according to the injection molding method of claim 7.

13. An airbag cover, comprising a first layer comprised of thermoplastic plastic, which has at least one first partial region with an essentially uniform layer thickness and at least one second partial region with a rip-open seam in the form of at least one recess, wherein to produce the first layer one cools a plasticized plastic that has been placed in a temperature-controlled casting mold until a degree of setting of the first layer is achieved that allows removal from the mold, whereupon the first layer is removed from the mold, wherein one adjusts the setting process in the second partial region of the first layer to the setting process in the first partial region by appropriately differing control of the courses of the temperature in the first partial region and the second partial region;
characterized in that the airbag cover has on its outer side a second layer that overlaps at least the at least one second partial region of the first layer, wherein the second layer is comprised of a different material than the first layer.

14. The airbag cover according to claim 13, characterized in that the second layer is comprised of a softer material than the first layer.

15. The airbag cover according to claim 14, characterized in that the second layer is comprised of plastic, textile, leather, a film, or a combination of these materials.

16. The airbag cover according to claim 13, characterized in that the second layer has a second rip-open seam, at least in its region that overlaps the at least one second partial region of the first layer.

17. The airbag cover according to claim 13, characterized in that the recess in the first layer is formed by a groove that has an essentially triangular or trapezoidal shape in a cross sectional plane perpendicular to the longitudinal direction of extent of the groove.

18. The airbag cover according to claim 17, characterized in that the groove penetrates completely through the first layer.

19. The airbag cover according to claim 17, characterized in that the groove ends at a distance (d₂) from the second layer which distance is about 0.1-0.5 times the thickness (d₃) of the first layer, preferably 0.1-0.2 times, particularly preferably 0.167 times (=⅙).

20. The airbag cover according to claim 17, characterized in that the groove partly penetrates the second layer.

21. The airbag cover according to claim 20, characterized in that the groove ends at a distance (d₅) from the side surface of the second layer which faces away from the first layer which distance (d₅) is about 0.1-0.75 times the thickness (d₆) of the second layer, preferably 0.2-0.6 times, particularly preferably 0.5 times.

22. The airbag cover according to claim 17, characterized in that in a plane perpendicular to the direction of extent of the groove, the groove at its narrowest point has a width (d₄) in the range about 0.1-1.0 mm, preferably in the range 0.1-0.5 mm.

23. The airbag cover according to claim 17, characterized in that the groove angle (α) included between the side surfaces (legs) of the groove, which legs are legs that extend in the direction of extent of the groove, is in the range 0-90°, preferably in the range about 20-30°.
